(19) United States
(12) Patent Application Publication
(10) Pub. No.: US 2026/0167157 A1
(43) Pub. Date: Jun. 18, 2026

(54) CLEANING DEVICE FOR ACCESS SYSTEMS, IN PARTICULAR FOR SLIDING STEPS ON VEHICLES

(71) Applicant: Bode - Die Tür GmbH, Kassel (DE)

(72) Inventors: Marco Cimmino, Adelebsen (DE); Ulrich Arend, Dickershausen (DE); Martin Reitz, Hofgeismar (DE)

(21) Appl. No.: 19/413,586

(22) Filed: Dec. 9, 2025

(30) Foreign Application Priority Data
Dec. 13, 2024 (DE) 20 2024 107 262.6

(51) Int. Cl. B60S 1/66; B08B 1/12; B08B 1/14

(52) U.S. Cl. CPC B60S 1/66; B08B 1/12; B08B 1/143

(57) ABSTRACT

A cleaning device for a step system includes a retractable and extendable sliding step and a cleaning element for a step surface. The cleaning element is arranged and embodied in such a way that on movement of the sliding step, the cleaning element removes foreign bodies situated on the step surface.

### CROSS-REFERENCE TO RELATED APPLICATIONS

This application claims the benefit of German patent application no. 20 2024 107 262.6, filed on 13 Dec. 2024, the disclosure of which is incorporated herein by reference in its entirety.

### TECHNICAL FIELD

The disclosure relates to a cleaning device for access systems, in particular for a step system with a retractable and extendable sliding step on rail vehicles or similar means of transport.

### BACKGROUND

Within project requirements, increasingly strict requirements are arising with regard to availability of step systems in various operating scenarios and environmental influences.

It is usual that in the region of the railway infrastructure in difficult winter conditions and at low temperatures, de-icing salt or similar is used, in order to safeguard passengers from minor or serious injuries such as falls. Depending on the destination and place of use, various foreign bodies are used for this (salt, grit, fine stone, etc.).

Depending on the grain size and characteristic (currently up to 20 mm), these foreign bodies can arrive onto the extended step or respectively the sliding step and can lead to disturbances such as multiple retraction attempts or even jamming of step systems. Foreign bodies =/>5 mm can become jammed temporarily or permanently through the movement (in particular the retraction movement) of the sliding step.

A gap between the underside of the step strip and the sliding step surface is inherent to the system. This gap (predominantly approximately 3 to 10 mm, mostly approximately 5 mm) is usually supplemented by a brush, in order to reduce the penetrating of dirt and foreign bodies into the interior of the step cassette or respectively of the vehicle. Often, however, such brushes only clean insufficiently in the case of coarse-grained foreign bodies.

### SUMMARY

The disclosure provides a device for protecting a sliding step system from jamming and being contaminated by foreign bodies. A cleaning system is to be provided which protects a sliding step system efficiently from jamming and from impairment by foreign bodies, and thus distinctly increases the system availability in particular in the case of the use of gritting agents. The functionality and availability of the sliding step system is also to be ensured under adverse environmental conditions. According to the disclosure, the problem is solved by providing a device with the features of the independent claim.

The device according to the disclosure keeps itself effectively distant from the foreign body approaching the gap and reliably cleans the sliding step or the step tread which substantially increases the availability of the system in critical operating states.

The disclosure relates to the cleaning of sliding steps and step treads equally, for which reason the terms are used synonymously in connection with the disclosure.

A cleaning element can be, for example, a clearing strip. Thus, in particular, foreign bodies of greater grain sizes are also kept away, smaller ones which are drawn in despite this first barrier, can be turned away by a brush which is used downstream in the direction of movement.

Advantageous example embodiments of the disclosure can contain a clearing strip with the following features:
a slightly angled contour, which brings it about that foreign bodies are activated at a very low force application point, and/or
having a flexible material, in order to be able to yield in extending direction in the event of foreign bodies, and to thus prevent a jamming and in order to be able to yield dimensionally in retracting direction in the event of foreign bodies, whereby also a higher prestressing is built up in the clearing strip, which activates and removes foreign bodies in borderline sizes with even greater effectiveness, and/or
segmented clearing elements, in order to be able to better activate rotationally asymmetrical foreign bodies. The clearing strip can therefore be embodied over its width in several segments which are movable independently of one another, which also guarantees an optimum cleaning in the event of irregularly distributed foreign bodies.

The cleaning device substantially increases the availability of the system in operating states with the use of gritting agent/grit. The maintenance effort is distinctly reduced. In particular, a particularly effective removal of foreign bodies of different size by a combination of at least one clearing strip and at least one brush is able to be achieved. The brush is arranged in insertion direction of the sliding step immediately behind the clearing strip.

The clearing strip preferably consists of a spring steel or also of a weather-resistant elastic plastic such as polyurethane or a thermoplastic elastomer. The brush has abrasion-resistant plastic bristles, which are resistant both to moisture and also to chemical influences (e.g. de-icing salt).

Advantageously, the cleaning device can be embodied as a retrofittable unit. For example, the cleaning device can have a step strip with cleaning elements arranged thereon, preferably at least one clearing strip and at least one brush. In existing vehicles, then only the present step strip has to be exchanged for the cleaning device according to the disclosure. The cleaning device is preferably constructed in a modular manner and can thereby be adapted particularly easily to different sliding step systems and vehicle types (e.g. bus, tram, underground train).

The at least one brush can preferably have various degrees of hardness, in order to remove both coarse and also fine particles. In particular, two or more rows of brushes, which can have different degrees of hardness or heights, can be arranged in the direction of movement of the sliding step.

Preferably also two or more clearing strips can be provided, which are also situated one behind the other in the direction of movement of the sliding step. The clearing strips can be identical, but they can also be embodied differently with regard to material, elasticity, geometric shape and alignment.

In a further preferred embodiment, the clearing strip is provided with an integrated heating element. The heating element can be operated electrically and prevents the adhering of ice and snow on the clearing strip, and brings about a stiffening of the clearing strip due to cold. The temperature regulation can take place for example via a thermal switch or a temperature sensor, which activates the heating element only when required. Thereby, the function of the cleaning device is also ensured in the case of extreme weather conditions.

The at least one brush can preferably be fastened to an elastic bearing, so that it adapts itself automatically to different heights of the step surface. This guarantees a consistently effective cleaning, even if the step surface changes slightly through wear or contamination.

In addition to the mechanical cleaning by the clearing strip and brush, the system can contain a spray nozzle which, as required, applies water or compressed air onto the step surface, in order to detach contaminations which are stuck. The control of the spray nozzle can take place manually or automatically.

The cleaning device can also be used in particular with extendable ramps for wheelchair users, in order to guarantee the secure function of the ramp. Ultimately, the cleaning device according to the disclosure is also suitable for extendable platforms or step surfaces of industrial systems, in order to increase the availability and safety there.

The disclosure is particularly well suited when corrugated metal sheets can not be used on the step surface. With the selection of corrugated sheet metal, the use of safety shutdown mats is technically not able to be used and consequently a mounted step tread with step sensing by means of a proximity switch is necessary (extension construction BiSS).

The cleaning device according to the disclosure can preferably be arranged in the region of the free end of the step strip, preferably in the region of the lower edge of the step strip aligned in the direction of the sliding step. The clearing strip can preferably be held in a recess of the step strip in this region. This recess extends along the front free end of the step strip, therefore over the width of the step strip and of the sliding step.

If an additional brush were to be provided, this is likewise arranged in this region, wherein the bristles of the brush extend in the direction of the sliding step. The brush can also be held in a groove arranged in the step strip, which groove preferably extends substantially parallel to the recess. It can, however, also be fastened on the step strip in a different suitable manner.

In a particularly advantageous embodiment variant, the clearing strip has a holding portion, via which it is fastened to the step strip. Adjoining this holding portion is a clearing portion which extends in the direction of the surface of the sliding step and preferably is manufactured from an elastic material. A middle portion can also be provided as transition between the holding portion and clearing portion. The holding portion can also be manufactured from a less elastic material.

The clearing strip or respectively its clearing portion has a slightly angled contour, in order to be able to engage foreign bodies as deeply as possible. This means that a free edge of the clearing strip is embodied to be offset or respectively bent slightly forward upwards in the extension direction of the sliding step.

The cleaning concept is based inter alia also on foreign bodies becoming wedged in front of the cleaning elements and being driven, shot as it were, outwards out of the gap through the elastic forces which are building up.

The clearing strip is deviated in insertion direction of the sliding step only on a contact with a foreign body and in an intermediate or middle position reaches an alignment in which the free edge of the clearing strip has the smallest distance with respect to a surface of the sliding step. Both in its initial position and also in its end position, the free edge of the clearing step is further remote from the surface of the sliding step than in the said intermediate or middle position.

It has been found that the clearing strip is particularly effective when the recess enables a movement of the clearing strip in the recess and it can move not only in the free space beneath the step strip.

Advantageously, the recess is arranged and embodied in such a way that on a contact, this can receive entirely or almost entirely the clearing strip with a foreign body, turning over upwards in the direction of an underside of the step strip or respectively moving upwards. The free edge of the clearing strip in the upwardly turned-over state then does not, or only scarcely, project with respect to an underside of the step strip in the direction of the sliding step. A sufficiently great depth and height of the recess, in particular the depth in the insertion direction of the sliding step, enable a great stroke or respectively a great pivoting movement of the clearing strip and hence a relatively long contact with the foreign bodies, whereby these can be cleared efficiently.

The recess can preferably be formed by a back offset of the lower free edge of the free end of the step strip, the free vertical height of which is for example approximately 30-60% of the height of the step strip and the depth of which in insertion direction of the sliding step is similarly great, therefore preferably likewise corresponds to approximately 30-60% of the height of the step strip.

In a particularly advantageous embodiment variant, the clearing strip has a clearing portion extending vertically from its free edge in the direction of the step strip, which clearing portion continues into a curved middle portion. The middle portion is embodied in a curved manner in the direction opposed to the free end of the step strip, therefore in the direction of a vehicle interior, and has a quasi horizontal region, which then continues, owing to the further curve shape, into an approximately vertically aligned holding portion extending again in the direction of the sliding step.

In the preferred example embodiment, a projecting holding strip is provided in the recess, which holding strip extends into a holding groove of the holding portion of the clearing strip. It is possible to plug the clearing strip onto the holding strip via the holding portion, and to thus fasten it quickly and easily in the recess. Alternatively, other forms are also possible, which enable such a snap or plug-on connection. The use of a plug-on connection simplifies the exchange of the clearing strip considerably. Alternatively, other frictional and/or form-fitting connections are also conceivable, which enable an easy, in particular tool-free exchange of the clearing strip.

The disclosure is explained more closely by means of the following figures, this is not to limit the disclosure; they are also not necessarily true to scale. The figures are intended to clarify the operating principle of the cleaning device.

Advantageously, the clearing strip is embodied and arranged in such a way that [] extending of the sliding step by an already drawn-in foreign body it can be pressed outwards in movement direction of the sliding step and can move around the latter or respectively over it without permanent deformation. A gap therefore occurs between the free edge of the clearing strip and the surface of the sliding step, which enables a directing back of foreign bodies in front of the clearing strip, in order to be able to direct these away on a renewed rejection attempt. In addition, an accumulating of foreign bodies behind the clearing strip is thereby effectively prevented.

### BRIEF DESCRIPTION OF THE DRAWINGS

There are shown in:

FIG. 1 a simplified schematic diagram of an advantageous embodiment variant of the cleaning device in cross-section,

FIG. 2 an illustration of a movement path of a clearing strip of a cleaning device according to FIG. 1 in cross-section.

### DETAILED DESCRIPTION OF THE DRAWINGS

The two figures show a cleaning device 20 advantageously according to the disclosure, in cross-section. The cleaning device 20 has as cleaning element a clearing strip 22, which extends in the direction of a sliding step 24. The clearing strip 22 is fastened to a step strip 26 and is arranged in such a way that its free clearing strip end or respectively its free edge 28 points in the direction of the sliding step 24. The clearing step 22 is arranged in the region of a free end 30 of the step strip 26 pointing in the extension direction of the sliding step 24. The direction of movement of the sliding step 24 is represented by the double arrow.

The step strip 26 has at its front free end 30 a recess 32, in which the clearing strip 22 is fastened. This recess 32 extends along the front free end 30 of the step strip 26, therefore substantially over the entire width of the step strip 26 and of the sliding step 24.

In the example embodiment which is shown, the clearing strip 22 has in cross-section a clearing portion 34 extending vertically from its free edge 28 in the direction of the step strip 26, which clearing portion continues into a curved middle portion 36. The middle portion 36 is curved in the direction opposed to the free end 30 of the step strip 26, therefore in the insertion direction of the sliding step 24, and has a quasi horizontal region, which then continues into a holding portion 38 and extends again in the direction of the sliding step 24.

Within the recess 32 a projecting holding strip 40 is arranged, which extends into a holding groove 42 of the holding portion 38 of the clearing strip 22. The clearing strip 22 is therefore held in a form-fitting and/or friction-fitting manner via its holding groove 42 onto the holding strip 40. Preferably, the clearing strip 22 is embodied in a sufficiently elastic manner in the region of the holding groove 42, in order to push the holding groove 42 into the holding strip 40 and to be able to pull it off therefrom.

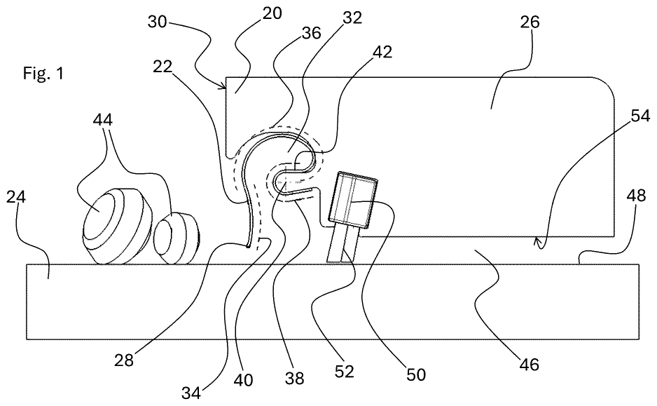

FIG. 1 shows foreign bodies 44, which are situated on a walkable surface 48 of the sliding step 24, but on retracting of the sliding step 24 are prevented by the clearing strip 22 from penetrating into a gap 46 between the step strip 26 and the sliding step 24.

It has proved to be particularly advantageous when at least one brush 50 is arranged in insertion direction of the sliding step 24 behind the clearing strip 22, the bristles 52 of which brush extend in the direction of the surface 48 of the sliding step 24 and also clean this. The brush 50 advantageously extends parallel to the clearing strip 22 over the entire width of the clearing strip 22. The brush 50 can, for example, also be arranged in a groove which extends approximately parallel to the recess 32 over the width of the step strip 26 or respectively of the sliding step 24.

In the example embodiment which is shown, the recess 32 has a height of approximately 30-60% of a height of the step strip 26 in the region of its free end 30, and an approximately identical depth in insertion direction of the sliding step 24.

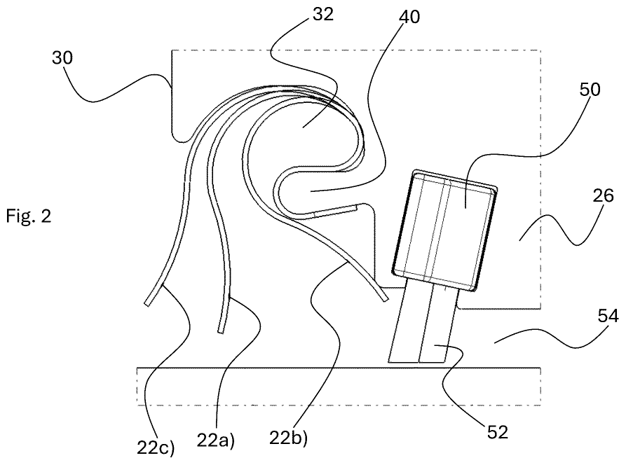

As can be seen in particular from FIG. 2, owing to the sufficient depth of the recess 32 on a contact of the clearing strip 22 with a foreign body 44, the recess receives entirely the clearing strip 22 turning over upwards in the direction of the underside 54 of the step strip 26 or respectively moving upwards. The free edge 28 of the clearing strip 22 then in the upwardly turned over state does not, or only scarcely, projects with respect to the underside 54 of the step strip 26 in the direction of the sliding step 24. The depth of the recess 32 in insertion direction of the sliding step 24 therefore preferably exceeds the length of the clearing portion 34 of the clearing strip 23, or respectively the recess 32 is deep in such a way that the entire turned over clearing strip 22 can be received therein.

FIG. 2 illustrates the movement sequence of the clearing strip 22 turning over in the insertion direction of the sliding step. Three positions of the clearing strip 22 are shown:
22 a): The clearing strip 22 is situated in the middle and unloaded position.
22 b): The clearing strip 22 is loaded by a foreign body 44, not shown, and deflects up to the stop on the step strip.
22 c): On extending of the sliding step 24, the clearing strip 22 is pressed outwards by an already drawn-in foreign body 44, and moves without permanent deformation around the latter or respectively over it. The shown position 22 c) thus enables a directing back of foreign bodies 44 in front of the clearing strip 22, in order to direct these away on a renewed rejection attempt. In addition, an accumulating of foreign bodies 44 behind the clearing strip 22 is thereby effectively prevented.

The disclosure is not limited to the described and shown embodiment variants, but rather also comprises further technical implementation possibilities of the disclosure.

1. A cleaning device for a step system, having a retractable and extendable sliding step and a cleaning element for a step surface, which is arranged and embodied such that on movement of the sliding step the cleaning element removes foreign bodies situated on the step surface.

2. The cleaning device according to claim 1, wherein the cleaning element is formed by a clearing strip of a flexible material, which is fastened in the region of a free end of a step strip pointing in the extension direction of the sliding step, and which extends into a gap between a step strip underside and a walkable surface of the sliding step.

3. The cleaning device according to claim 2, wherein the step strip has at a front free end a recess in which the clearing strip is fastened, wherein the recess extends along the front free end of the step strip approximately over the entire width of the step strip and of the sliding step.

4. The cleaning device according to claim 2, wherein a free edge of the clearing strip embodied curved forward upwards in the extension direction of the sliding step, whereby the clearing strip has an angled contour in extension direction of the sliding step, to activate and direct away foreign bodies at a low force application point.

5. The cleaning device according to claim 2, wherein the clearing strip has in cross-section a clearing portion extending vertically from a free edge in the direction of the step strip, which clearing portion continues into a curved middle portion, wherein the middle portion is embodied in a curved manner in the direction opposed to the free end of the step strip, and has a region running substantially horizontally, which then continues into a holding portion and extends again in the direction of the sliding step.

6. The cleaning device according to claim 3, wherein the recess is arranged and embodied such that the recess is configured to receive almost entirely the clearing strip turning over upwards in the direction of an underside of the step strip, so that a free edge of the clearing strip in the upwardly turned over state does not, or only scarcely, project with respect to the underside of the step strip in the direction of the sliding step.

7. The cleaning device according to claim 3, wherein the recess is formed by a back offset of the lower free edge of the free end of the step strip, the free vertical height of which corresponds to approximately 30-60% of the height of the step strip and the depth of which in insertion direction of the sliding step corresponds to approximately 30-60% of the height of the step strip.

8. The cleaning device according to claim 1, wherein the clearing strip is fastened detachably on the step strip.

9. The cleaning device according to claim 3, wherein within the recess a projecting holding strip is arranged, which extends into a holding groove of the holding portion of the clearing strip.

10. The cleaning device according to claim 2, wherein the clearing strip is formed in a segmented manner.

11. The cleaning device according to claim 2, wherein in insertion direction of the sliding step behind the clearing strip a brush is arranged, the bristles of which extend in the direction of the surface of the sliding step.

12. The cleaning device according to claim 2, wherein the brush extends parallel to the clearing strip over the entire width of the clearing strip.
